(19) United States
(12) Patent Application Publication
(10) Pub. No.: US 2016/0369680 A1
(43) Pub. Date: Dec. 22, 2016

(54) IMPROVED SYSTEM FOR STORING A LIQUID ADDITIVE

(71) Applicant: INERGY AUTOMOTIVE SYSTEMS RESEARCH (SOCIÉTÉ ANONYME), Bruxelles (BE)

(72) Inventors: Nicolas MANGEOL, Paris (FR); Frederic GUIGNERY, Mery-Sur-Oise (FR); Philippe GEORIS, Chelles (FR)

(73) Assignee: PLASTIC OMNIUM ADVANCED INNOVATION AND RESEARCH, Bruxelles (BE)

(21) Appl. No.: 15/101,247

(22) PCT Filed: Dec. 2, 2014
(86) PCT No.: PCT/FR2014/053125

§ 371 Date: Jun. 2, 2016

(30) Foreign Application Priority Data
Dec. 2, 2013 (FR) 1361953

(51) Int. Cl. F01N 3/28; B67D 7/02; B67D 7/42; F01N 3/20

(52) U.S. Cl. CPC F01N 3/2896; F01N 3/206; B67D 7/0288; B67D 7/42

(57) ABSTRACT

The invention relates to a system (2) for storing a liquid additive to be injected into the exhaust gases of an internal combustion engine of a vehicle, comprising: an additive storage tank (4) comprising means for setting a maximum filling level of the tank, an additive retention capacity which fluidically communicates with the tank (4), said capacity being designed so as to retain the additive coming from the tank, wherein the additive retention capacity and the tank (4) are adjacent and have at least one common wall (8).

The present invention relates to a storage system for a liquid agent for reducing oxides of nitrogen (typically referred to as NOx) in the exhaust from an internal combustion engine of a vehicle. Such liquid agents, for example a solution of urea, are typically injected upstream of the exhaust of a vehicle in order to help to reduce the level of NOx in the exhaust. This storage system is part of a system known as “SCR” (corresponding to the expression Selective Catalytic Reduction) for reducing the level of oxides of nitrogen, or NOx, in the exhaust gases.

Such a system, comprising a tank, a filler pipe for the liquid agent and a ventilation pipe for the evacuation of the air initially contained in the tank as the filling of said tank proceeds, is already familiar from the prior art.

A problem associated with this type of system is that, when the liquid level reaches the maximum level leaving a residual air headspace, a sharp increase occurs in the pressure inside the headspace causing the external discharge of liquid agent forced out via the ventilation line (a phenomenon often referred to as “spitback”).

In addition, the filler and ventilation pipes typically remain at least partially filled with liquid agent after filling, which may lead to freezing problems under certain conditions.

However, it is also a familiar storage system comprising a buffer volume (or retention capacity) disposed at an intermediate part of the ventilation pipe. A buffer volume of this kind (often referred to as a “liquid trap”), makes it possible to receive the liquid entering via the ventilation pipe, and to store this liquid temporarily during the final stages of filling the tank in order to prevent any discharge towards the outside. A draining hole permits the liquid contained in the buffer volume to be returned into the tank, after filling said tank. A system of this kind thus permits the phenomenon of spitback to be avoided, although at the cost of an additional component (buffer volume) resulting in increased complexity, additional connections and a higher overall component cost as well as a higher assembly cost. In addition, said additional capacity imposes technical risks and constraints relating to vibrations, which involves the implementation of specific means of attaching and clamping the capacity to the supporting structure of the vehicle (chassis or structural elements). Generally, one or a plurality of connectors are used to connect said capacity to the ventilation pipe. The use of such connectors may present sealing problems and may make assembly more complicated.

A principal aim of the invention is to eliminate or, at least substantially, to limit all or part of the aforementioned disadvantages.

With this aim in mind, an object of the invention is a system for storing a liquid additive intended to be injected into the exhaust gases from an internal combustion engine of a vehicle, comprising:

an additive storage tank comprising means for setting a maximum filling level of the tank,

an additive retention capacity in fluidic communication with the tank, said capacity being designed so as to retain additive coming from the tank,

characterized in that the additive retention capacity and the tank are adjacent and comprise at least one common wall.

The additive retention capacity in fluidic communication with the tank is typically designed to receive and retain the additive during a final phase of filling the tank, and then to permit the at least partial drainage of the received additive into the tank after filling the tank.

The expression additive retention therefore applies typically to temporary retention, at least for a part of the received additive.

Furthermore, the system is typically intended to be installed in a specific position on the vehicle, thereby permitting the retention of additive and typically its subsequent drainage.

The design of the capacity with a common wall with the tank makes it possible to obtain a system that is much more compact than a conventional system, that is more simple to manufacture, and that allows savings in materials. This also makes it possible to prevent vibrations of the capacity, typically being of a volume smaller than that of the tank, by making it intrinsically integral with the tank, the tank and the capacity together forming a single structure. The capacity has the securing means for the tank, of which it increases the mass, which limits the vibrations and the risks of resonance of the capacity without the requirement for its own means of attachment and clamping to the structure of the vehicle.

The common wall typically comprises a passage designed to place the capacity in fluidic communication with the tank, said passage typically being formed by a duct passing through the common wall.

This permits any leaks in the joints and connections of the tank/capacity to be limited in the conventional storage system. The leaks around the fluidic communication passage are not external leaks, in fact, but are secondary internal flows of the liquid additive.

This makes it possible further to reduce the number of connecting elements, the communication between the tank and the capacity being implemented by means of a simple orifice.

The system is typically intended to be installed in a specific position, and comprises the duct and means for the at least partial drainage of the capacity into the tank, via said duct and/or via at least one draining orifice (the system being viewed in said specific position).

The duct (passing through the common wall) advantageously comprises a first part extending into the interior of the capacity, said first part of the duct comprising at least a first draining orifice. The liquid, or at least a part of the liquid retained in the capacity, may thus be drained into the tank.

Advantageously, the duct also comprises a second part extending into the interior of the tank as far as the maximum level of filling of the tank.

Said second part of the duct preferably comprises at least a second orifice, for the release of pressure (and/or a gas ventilation orifice, avoiding the build-up in pressure in the tank).

The common wall may also comprise at least a third draining orifice. This may make the drainage more rapid.

According to a first mode of implementation of the storage system, the system comprises a filler nozzle which discharges into the tank without passing through the capacity.

According to a second preferred mode of implementation of the storage system, the system comprises a filler nozzle which passes through the capacity and then discharges into the tank, and preferably extends towards the bottom in the interior of the tank.

The filler nozzle is preferably made from the same material as a wall of the capacity. This makes it possible to manufacture the tank and the capacity in two parts, the filler nozzle (which demands high geometrical accuracy since it is necessary to produce an airtight connection with a filler pipe) belonging to a different intermediate component of the tank, having relatively small dimensions, and to avoid complicating the design of the mold for manufacturing the tank, this being the principal component, as described below.

According to a variant embodiment of said second mode of implementation, the filler nozzle of the tank passes into a fourth orifice provided in the common wall, thereby delimiting between said filler nozzle and an edge of said fourth orifice a space for the fluidic communication between the tank and the capacity. This also makes it possible to simplify the design of the mold for manufacturing of the tank, as described below.

In general, the filler nozzle (optionally in two parts with a connection) discharges into the tank and preferably extends towards the bottom in the interior of the tank, preferably as far as a level lower than the maximum filling level. This limits the height of the fall of the liquid and the formation of droplets of liquid that may be carried along together with the ventilated gas towards the outside.

The system typically functions in the following manner: During filling of the tank, when the liquid level reaches the maximum filling level (end of filling), the pressure increases inside the tank, as a consequence of a major reduction in or an interruption of the ventilation of the gaseous headspace, thereby triggering the interruption of the filling. This interruption is not instantaneous, however. As a result, a supplementary volume of additive continues to be introduced into the tank, partially filling the capacity, via the fluidic communication passage. Following the complete interruption of the filling, a part, or preferably the totality of said additive is then drained from the capacity into the tank, in order typically to form a single volume of additive, which is less susceptible to freezing than a plurality of separate volumes. Obtaining a single volume avoids the need for a dead volume of additive that is not usable.

The pressure release orifice (and/or gas ventilation orifice) permits the achievement of effective drainage indirectly, by evacuating from the headspace of the tank a volume of gas that is substantially identical to the volume of drained additive.

Typically, the cross section of the first orifice, and/or that of the second orifice, and/or that of the third orifice is much smaller (for example from 2 to 40 times smaller, or preferably from 3 to 30 times smaller) than that of the fluidic communication passage, for example that of an inlet orifice of this passage, or, where appropriate, a diameter of the duct, in such a way as not to prevent triggering of the interruption of the filling by increasing the pressure when the level in the tank reaches the filling level.

The system comprises a filler nozzle discharging into the tank, adapted for connection, externally to the tank, to a filler pipe. It also comprises a ventilation nozzle, belonging to the capacity, for connection, externally to the capacity, to a ventilation pipe.

The connections between the nozzles and the pipes may be of any type (for example threaded connections, connections with a clamping ring, etc.), or they may even be implemented by welding or gluing.

The system may likewise typically comprise other conventional components, for example a non-return valve disposed in the interior of the filler nozzle.

The filler and ventilation pipes may be considered, according to the invention, either as being external to the storage system, or, by extension, as belonging to the storage system.

The invention also covers a system for the supply and storage of additive comprising:
a storage system as previously described;
a filler pipe for the tank connected to the filler nozzle.

The invention also covers a system for the supply and storage of additive, and for the ventilation of gas, comprising:
a system for the supply and storage of additive as previously mentioned;
a ventilation pipe connected to a ventilation nozzle belonging to the capacity.
   Typically, the ventilation pipe connects the capacity to the filler pipe of the tank at a point situated outside the tank and the capacity.

In the storage system according to the invention, the means for the detection of a maximum level of filling of the tank often comprise, or may be formed by, an inlet orifice of a principal passage for fluidic communication between the tank and the capacity, forming the principal gas ventilation orifice, and disposed at the maximum filling level, said maximum filling level being situated at a level lower than a maximum interior level of the tank.

The tank, the capacity, the filler pipe of the tank and the ventilation pipe are typically molded in one or a plurality of plastic materials, that is to say in material(s) comprising at least a synthetic resin polymer, said elements being produced by molding, typically by injection.

All types of plastic material that are capable of storing the additive may be suitable. Plastic materials offering good suitability belong to the category of thermoplastic materials.

The expression thermoplastic material is used to denote any thermoplastic polymer, including thermoplastic elastomers and mixtures thereof. The expression “polymer” is used to denote both homopolymers and copolymers (binary or ternary in particular). Examples of such copolymers include, but are not limited to: copolymers having a random distribution, sequenced copolymers, block copolymers and graft copolymers.

Any type of polymer or thermoplastic copolymer, of which the melting temperature is lower than the decomposition temperature, is suitable. Synthetic thermoplastic materials which exhibit a melting temperature spread over a range of at least 10 degrees Celsius are particularly suitable. Examples of such materials include those which exhibit a poly-dispersion of their molecular mass.

In particular, polyolefins, thermoplastic polyesters, polyketones, polyamides and their copolymers can be used. A mixture of polymers or copolymers may also be used, as well as a mixture of polymeric materials with inorganic, organic and/or natural fillers such as, for example, but not limited to: carbon, salts and other inorganic derivatives, natural or polymeric fibers. It is also possible to use multi-layer structures constituted by stacked and integral layers comprising at least one of the polymers or copolymers as previously mentioned.

A polymer that is often used is polyethylene. Excellent results have been obtained with high-density polyethylene (PEHD).

The system is typically designed, after filling the tank up to the filling level of the tank, the latter triggering a non-instantaneous interruption of the filling, so as to permit the reception and the retention of additive in the capacity, with partial filling of said capacity, and subsequently so as to permit the at least partial drainage of the additive received from the capacity into the tank.

The invention also relates to a method for manufacturing a system of the kind mentioned above, in which:
molding of a first plastic material, for example by injection, is used to produce a first component comprising the complete wall of the tank and a first part of the wall of the capacity which is not common with the tank,
molding, for example by injection, of a second plastic material, preferably identical to the first plastic material, is used to produce a second component comprising a second part of the wall of the capacity which is not common with the tank, complementary to said first part of the wall of the capacity, said second part of the wall of the capacity comprising a filler nozzle and a ventilation nozzle,
the first and second parts of the wall of the capacity are welded to form the capacity.

The invention will be better understood from a perusal of the description of the accompanying figures, in which:

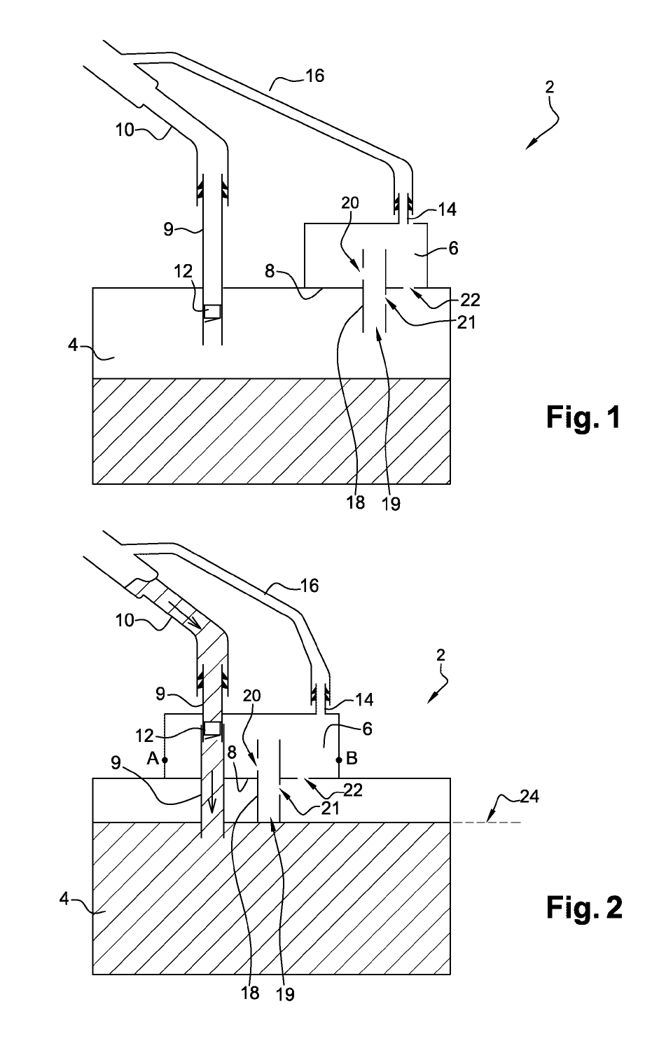

FIG. 1 represents schematically a storage system according to the invention according to the first mode of implementation, and also a system for the supply and storage of additive, and for the ventilation of gas.

FIG. 2 represents schematically a storage system according to the invention according to the second mode of implementation, in a first configuration, and also a system for the supply and storage of additive, and for the ventilation of gas.

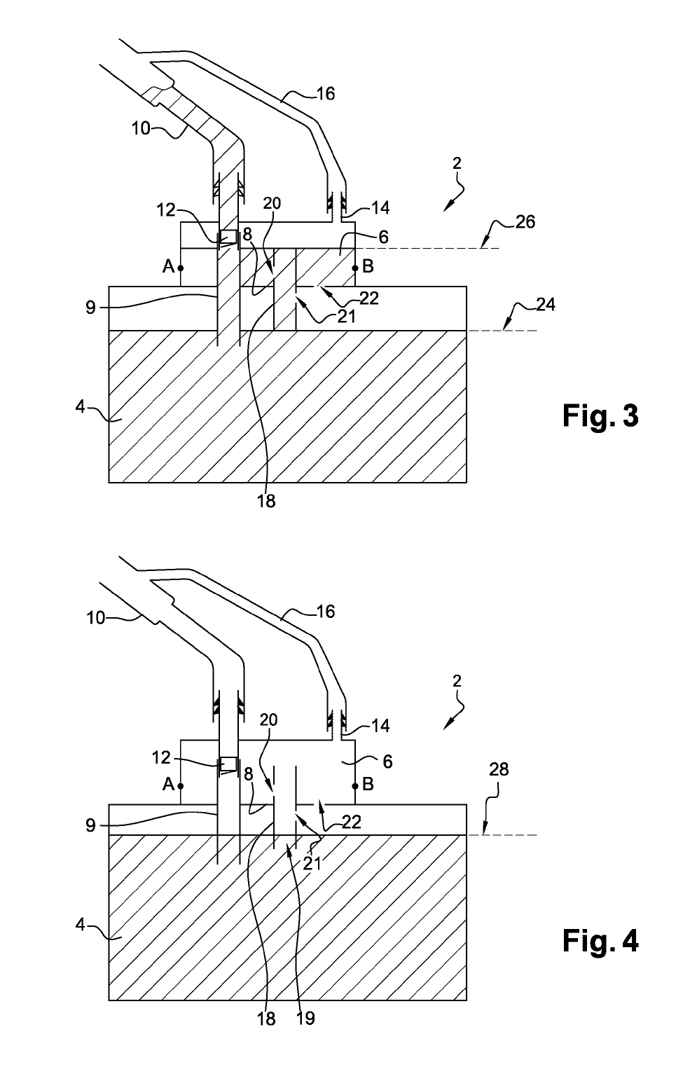

FIG. 3 represents schematically the system depicted in FIG. 2, in a second configuration, and also a system for the supply and storage of additive, and for the ventilation of gas.

FIG. 4 represents schematically the system depicted in FIG. 2, in a third configuration.

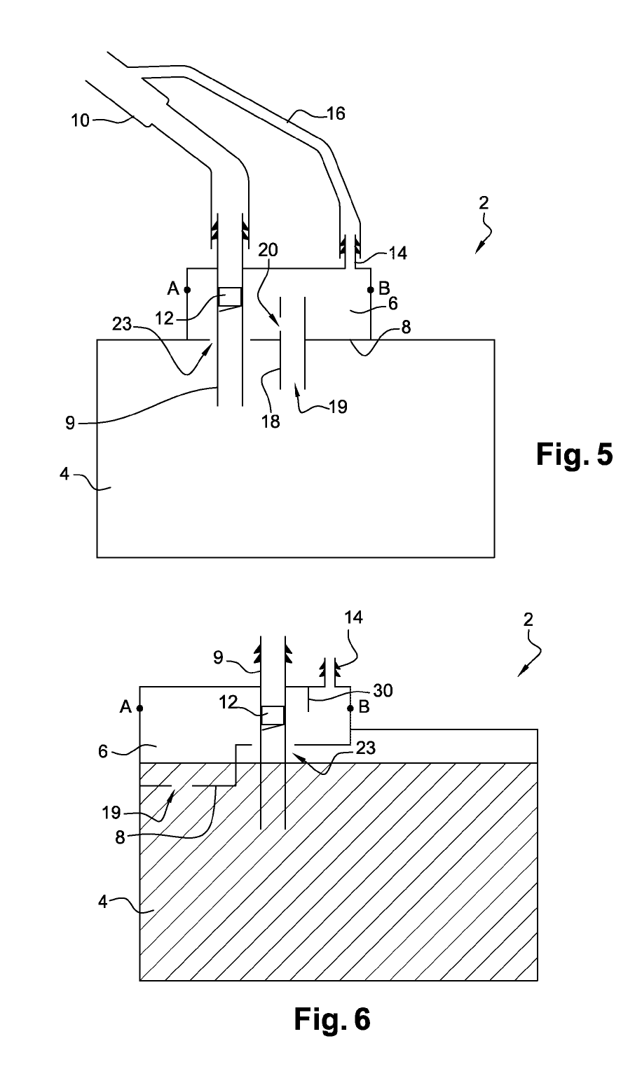

FIG. 5 represents schematically a storage system according to the invention according to a first variant of the second mode of implementation, and also a system for the supply and storage of additive, and for the ventilation of gas.

FIG. 6 represents schematically a storage system according to a second variant of the second mode of implementation.

Reference is now made to FIGS. 1 to 5, and in the first instance to FIG. 1, which represents a storage system 2, comprising a tank 4, adjacent to a capacity 6, the tank 4 and the capacity 6 comprising a common wall 8.

The system also comprises a filler nozzle 9 adapted for attachment to a filler pipe 10, the filler nozzle 9 comprising a non-return valve 12.

The system also comprises a ventilation nozzle 14 adapted for attachment to a ventilation pipe 16 connecting the capacity 6 to the filler pipe 10 of the tank at a point situated outside the tank 4 and the capacity 6.

The overall assembly, which is not referenced, constitutes a system for the supply and storage of additive, and for the ventilation of gas.

A duct 18 passing through the common wall 8 forms a passage 19 for fluidic communication between the tank 4 and the capacity 6.

The system also comprises a first draining orifice 20, disposed on a first lateral part of the duct 18, which extends to the interior of the capacity, and a second orifice 21, for the release of pressure (and/or gas ventilation orifice), disposed on a second lateral part of the duct 18, which extends to the interior of the tank. Finally, it comprises a third draining orifice 22, disposed on the common wall 8.

The storage system according to the invention generally comprises only the aforementioned elements, with the exception of the filler pipes 10 and the ventilation pipes 16, as in the system represented in FIG. 6. A complete system for the supply and storage of additive and for the ventilation of gas is obtained with these pipes.

FIG. 2 represents, with the same references, an illustrative embodiment according to the second mode of implementation of the storage system (and likewise of the system for the storage and filling of additive, and for the ventilation of gas), in a first configuration corresponding to a moment of the filling of the tank at which the level of the additive reaches the filling level 24, thereby triggering the non-instantaneous interruption of the filling. It can be noted that, in this second mode of implementation, the filler nozzle 9 passes through the capacity 6 before discharging and extending towards the bottom in the interior of the tank 4. It will be appreciated that the expression filler nozzle comprises a connection for attachment to a filler pipe, but that it may likewise comprise a section of duct for the supply of additive in the course of filling the tank (in a single part or optionally a plurality of parts having one or a plurality of internal connections).

The walls of the capacity comprise points A and B and a ventilation nozzle 14, the function of said elements being explained below.

The system depicted in FIG. 2 can be seen in FIG. 3 in a second configuration corresponding to a moment of the filling of the tank at which the interruption of the supply of additive becomes effective. It may be noted that a certain volume of additive partially fills the capacity, as far as the level 26 (this level not necessarily corresponding to the upper nozzle of the duct 18).

From this moment on, the gravity drainage of the capacity 6 may take place naturally, the liquid flowing in the duct 18 towards the tank via the first draining orifice 20, a part of the gas contained in the tank (gaseous headspace) being evacuated via the second orifice 21. Liquid may likewise be drained into the tank via the third draining orifice 22. The third orifice 22 may also evacuate a little gas from the headspace of the tank, with countercurrent passage of the gas and the liquid.

The use of two separate orifices 20 and 21 for drainage and ventilation makes it possible to achieve more rapid drainage, and to prevent the complete countercurrent passage of the gas and the liquid.

The configuration represented in FIG. 4 is obtained at the end of the drainage, substantially the totality of the additive contained in the capacity 6 having been drained into the tank 4, which then reaches the level 28.

To manufacture the system represented in FIGS. 2 to 4, as regards the tank 4 and the capacity 6, manufacturing in two parts is preferably carried out advantageously by plastic injection molding:
molding is used to produce a first intermediate component comprising the complete wall of the tank 4 and a first part of the wall of the capacity which is not common with the tank, comprising the portions of said capacity represented in FIGS. 2 to 4 below points A and B;
molding is used to produce a second intermediate component comprising a second part of the wall of the capacity which is not common with the tank, complementary to said first part of the wall of the capacity, said second part of the wall of the capacity comprising the portions of said capacity represented in FIGS. 2 to 4 above points A and B, as well as a part of the filler nozzle 9 which is adapted for connection to a filler pipe 10 and the ventilation nozzle 14. The elements of the second component are represented with bold lines in FIG. 4.
the first and second parts of the wall of the capacity are then welded to form the capacity.

This offers important advantages: the filler nozzle 9 comprises a connection which demands high geometrical accuracy, since it is a component of an external airtight connection with the filler pipe 10. To produce this connection on the tank itself would involve the implementation of a mold with large dimensions (those of the tank) of particularly complex design. On the other hand, the manufacture of said part for the connection of the filler nozzle integrally with the upper part of the capacity, which is typically a second molded component having relatively small dimensions, is much easier to achieve at the time of designing the corresponding mold.

FIG. 5 represents a first variant of the second mode of implementation of the system represented in FIGS. 2 to 4. In said first variant, the filler nozzle 9 passes through the fourth orifice 23, determining an annular space between the filler nozzle 9 and an edge of said orifice 23, adapted for the release of pressure, and/or for the ventilation of gas, and/or for drainage. This variant makes it possible to simplify the principal mold for manufacturing the tank, the tank not comprising a terminal part of the filler nozzle 9.

Finally, FIG. 6 represents partially a second variant embodiment of the second mode of implementation of the system, in a configuration after drainage. In said second variant, the fluidic communication passage 19 is a simple orifice of relatively large diameter and does not comprise a duct such as the duct 18 represented in the previous figures. A baffle 30 makes it possible to prevent liquids from being carried along in the ventilation pipe when the additive enters into the capacity 6.

In said variant, the fluidic communication passage 19 performs the function of a draining orifice. After drainage, the liquid level of the additive in the capacity 6 and the tank 4 is identical, and the additive continues to form a single volume, without any dead volume. The drainage is not total, on the other hand, and the capacity 6 contains a part of the additive after drainage and as such contributes, in a limited manner, to the storage of the additive. The design of the mold for the manufacture of the tank is even simpler in said variant, since the tank does not comprise any tubular part (any duct).

The invention is not restricted to the proposed modes of implementation, and other modes of implementation will be clearly appreciated by a person skilled in the art. In particular, it is also possible to use a ventilation pipe adjoining the tank, for example connecting a wall of the tank which is not part of the common wall 8 to a part situated upstream of the filler pipe 10, in order to achieve equalization of the tank pressure with the ambient pressure, if necessary through a porous element in order to limit the breathing of the tank.

Also, any other element or device familiar from the prior art that is compatible with the invention may be utilized.

1. A system for storing a liquid additive intended to he injected into the exhaust gases from an internal combustion engine of a vehicle, comprising:
an additive storage tank comprising means for setting a maximum filling level of the tank,
an additive retention capacity in fluidic communication with the tank, said capacity being designed so as to retain additive coming from the tank,
wherein the system comprises:
a filler nozzle discharging into the tank and adapted for connection to a filler pipe of the tank,
a ventilation nozzle adapted for attachment to a ventilation pipe connecting the capacity to the filler pipe of the tank at a point situated outside the tank and the capacity,
and in that the additive retention capacity and the tank are adjacent and comprise at least one common wall.

2. The system as claimed in claim 1, in which the common wall comprises a passage designed to place the capacity in fluidic communication with the tank.

3. The system as claimed in claim 2, wherein said passage is formed by a duct passing through the common wall.

4. The system as claimed in claim 3, in which the duct comprises a first part extending into the interior of the capacity, said first part of the duct comprising at least a first draining orifice, and a second part extending into the interior of the tank as far as the maximum level of filling of the tank.

5. The system as claimed in claim 4, in which said second part of the duct comprises at least a second orifice, for the release of pressure.

6. The system as claimed in claim 1, in which the filler nozzle passes through the capacity and then discharges into the tank, and preferably extends towards the bottom in the interior of the tank, the filler nozzle of the tank preferably being made from the same material as a wall of the capacity.

7. The system as claimed in claim 6, in which the filler nozzle of the tank passes into a fourth orifice provided in the common wall, thereby delimiting between said filler nozzle and an edge of said fourth orifice a space for fluidic communication between the tank and the capacity.

8. The system as claimed in claim 1, in which the tank and the capacity are formed in one or a plurality of plastic materials, and are produced by injection molding.

9. The system as claimed in claim 1, designed, after filling of the tank up to the maximum filling level of the tank, the latter triggering the non-instantaneous interruption of the filling, so as to permit the reception and the retention of additive in the capacity, with partial filling of said capacity, and subsequently so as to permit the at least partial drainage of the capacity into the tank.

10. A method for manufacturing an additive storage system as claimed in claim 6, in which:
molding of a first plastic material, for example by injection, is used to produce a first component comprising the complete wall of the tank and a first part of the wall of the capacity which is not common with the tank;
molding, for example by injection, of a second plastic material, preferably identical to the first plastic material, is used to produce a second component comprising a second part of the wall of the capacity which is not common with the tank, complementary to said first part of the wall of the capacity, said second part of the wall of the capacity comprising one part at least of the filler nozzle which is adapted for connection to a filler pipe, and a ventilation nozzle;
the first and second parts of the wall of the capacity are welded in order to form the capacity.
